(19) United States
(12) Patent Application Publication
(10) Pub. No.: US 2003/0194079 A1
(43) Pub. Date: Oct. 16, 2003

(54) Method and system for remotely delivering identification tags

(76) Inventor: James D. Scott, Scottsdale, AZ (US)

Correspondence Address: WEISS & MOY PC, 4204 NORTH BROWN AVENUE, SCOTTSDALE, AZ, 85251, US

(21) Appl. No.: 10/122,051

(22) Filed: Apr. 15, 2002

(51) Int. Cl. H04M 3/00; H04M 5/00

(52) U.S. Cl. 379/245

(57) ABSTRACT

A method and system for remotely delivering identification tags permits an owner of property to create an identification tag whereby a finder of the property can contact the owner via a centralized system. The Internet may be used to deliver uniquely identifying information to the owner's endpoint computer system and using that information, the owner may generate the identification tag. Alternatively, a point-of-sale system may be used to provide more sophisticated identification tags than may be produced with a typical personal computer printer. The point-of-sale system may include an engraver, printer/laminator or other output device for producing a durable high-quality identification tag.

### BACKGROUND OF THE INVENTION

1. Field of the Invention

The present invention relates generally to identification tag systems, and more specifically, to a method and system for delivering identification tags remotely over a network.

2. Background of the Invention

Present-day network systems communicate through a variety of channels in order to interconnect computers, telephony devices and other systems such as point-of-sale devices and printers that require graphical and database information to provide remote services.

Lost and found identification systems are currently marketed that permit an owner of a pet or other valuable property to tag the property with an identification tag containing a contact telephone number to a central information service and a unique identifier. The unique identifier permits the central information service to locate the property owner by looking up the unique identifier in a database. The identification systems that are presently in use are marketed at pet supply stores or other locations where an owner can obtain an identification tag that will permit a finder to notify the owner that an article bearing the identification tag has been found. However, the owner of the article typically must wait to obtain the identification tag from the vendor. The tags are typically sent to the owner of the article via mail.

U.S. Pat. No. 5,878,116 describes a method and system for identifying property that includes a computerized voice-messaging-type system. That method facilitates reunion between an owner/caretaker of property and a finder. However, this method and system does not take further advantage of the Internet and other networking systems and the property owner still has to obtain the identification tag.

Therefore, it would be desirable to provide a method and system for remotely delivering identification tags wherein the identification tags may uniquely identify a property owner and/or property so that the property owner may be located when the property is found.

### SUMMARY OF THE INVENTION

The above objective of remotely delivering identification tags is achieved in a method and system that transmits identification tag information to a user over a network. The method transmits a request to generate an identification entry from a network endpoint to a centralized identification database system, generates the identification entry at said centralized identification database system and then transmits information corresponding to the identification entry from the centralized identification database system to the network endpoint for generating an identification tag at the network endpoint. The generated identification tag contains information for a finder of an article to contact an owner of said article.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a block diagram depicting a networked computer system in which a preferred embodiment of the invention may be practiced.

FIG. 2 is a pictorial diagram depicting an Internet browser displayed on the graphic display of FIG. 1, having graphical output in accordance with a preferred embodiment of the invention.

FIG. 3 is a flowchart depicting operation of an identification system in accordance with a preferred embodiment of the invention.

### DETAILED DESCRIPTION OF THE PREFERRED EMBODIMENTS

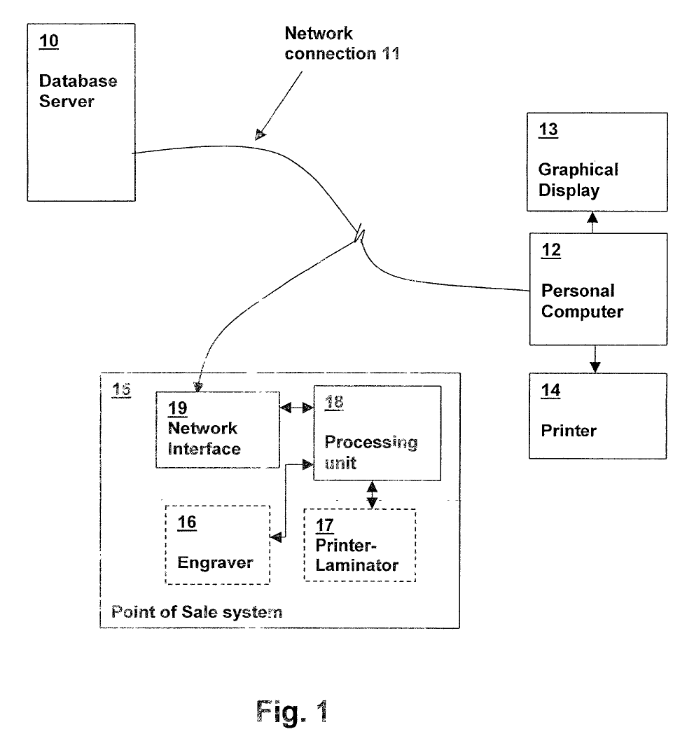

Referring now to the figures and in particular to FIG. 1, a network within which a preferred embodiment of the present invention may be practiced is depicted in a block diagram.

A database server 10 contains signal-bearing media in the form of hard disk storage having program instructions for practicing the method of the present invention. Database server 10 is coupled to other network components via network connection 11, which may be an Ethernet connection coupled to routers, bridges or other terminal equipment for connection to a wide-area network. As such, network connection 11 represents a connection to the Internet or other suitable platform for connection to remote systems such as a point of sale system 15 and a personal computer 12.

The present invention uses the network depicted in FIG. 1 to remotely deliver identification information so that identification tags may be produced at a remote network endpoint such as point of sale system 15 or personal computer 12. When a user having access to a personal computer 12 coupled to network connection 11 wishes to purchase an identification tag for their property, a request is sent via network connection 11 from personal computer 12 to generate a property identifier. Alternatively, the identifier may identify the owner and the property owner may then re-use the identifier for tagging multiple articles.

In one embodiment of the present invention, personal computer 12 contains a network browser program for interacting with graphical display 13 and input device such as a keyboard and mouse (not shown) in order to provide access to the world-wide-web. Database server 10 may be accessed via instructions contained in a web page that exists as a file that may be contained within database server 10 or in another location on the Internet. The instructions within the web page may generate a request to database server 10 to generate an identification entry within a database in database server 10 and database server 10 will return identification information for generating an identification tag.

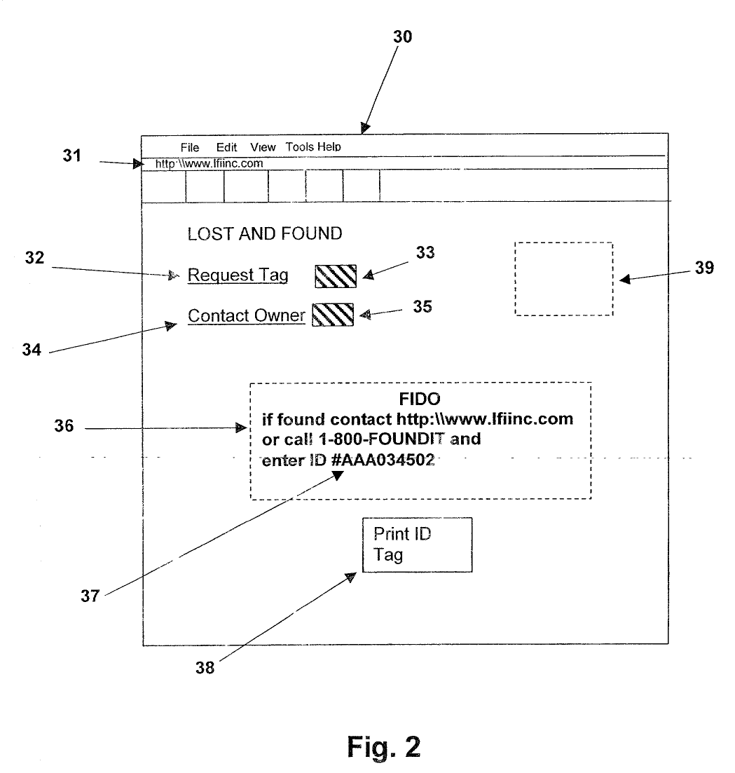

Referring now to FIG. 2, graphical output of a browser program interacting with the above-described web-page is depicted as an output as might be displayed on graphical display 13. Browser output 30 may be of a type generally in use, such as Navigator (manufactured by Netscape) or Internet Explorer (manufactured by Microsoft). A location bar 31 permits the user of the browser to direct the browser to interact with a web page (www.lfiinc.com in this example). Browser output 30 depicts the graphical content of a web page, which may contain advertising link icons 39, and items associated with operation of the present invention. In the exemplary browser output, all of the operational items associated with the example are depicted as being located within one web page, but multiple pages may be used to separate the various steps associated with generating an identification tag. Additionally, the exemplary browser output depicts a hot area 34 for a finder of an article having an identification tag affixed to notify the owner of the article. This hot area 34 may be embodied in a separate web page or located on a separate web site.

Hot area 32 causes a request to be sent to database server 10 when the user clicks on the text “Request Tag.” Similarly, a button 33 may provide this same functionality or both may be provided. When a request for generating an identification tag is received by database server 10 the resulting response containing identification information may be used to create a graphical representation 36 of the identification tag on graphical display 13. The identification tag may contain the name of the pet or owner, but will contain the identification number returned by database server 10 a contact web page address and/or a telephone number permitting a finder of the article to which the identification tag is affixed to notify the owner of the article. The card may contain a 1-800 toll-free number for contact, or a calling card number giving the finder free access to the telephone network. Additionally, the calling card may be printed as a full calling card on the reverse side of the identification tag. Advertising information may also be included.

After the user has viewed graphical representation 36, the user may direct personal computer 12 via print button 38 to print the identification tag on printer 14. The tag may then be affixed to the article. Fasteners, labels or other means may be employed to generate or affix the identification tag. For example, printer 14 may print tags on standard adhesive-backed labels, or holders may be supplied for insertion of tags cut from standard paper stock.

A web page identified on an identification tag may be accessed by a finder of an article to which the identification tag is affixed. For simplicity of illustration, hot area 34 is depicted as provided for a person to contact an owner of a found article to which an identification tag is affixed. In practice, this functionality may be contained on a different web page, or at a different web site. When hot area 34 or an associated button 35 is activated, the user is prompted to enter the identification number found on the tag, then a request is sent to database server 10, which looks up the identification number and provides a notification to the owner of the article to which the identification tag is affixed. Notification of an owner may be by voice messaging to a telephone voice mailbox or via email. The operation of voice messaging mailbox systems and email systems is described in the above-incorporated patent application “METHOD OF LOCATING A LOST PET, PERSON OR OBJECT” and the present invention may be embodied in a system that incorporates the voice messaging features of the above-incorporated patent application by providing a telephone number to the voice-messaging system on the remotely delivered identification tag. Alternatively, contact may be made by automatically generating a voice message via an Internet-coupled voice modem or by directly generating an e-mail message over network connection 11 from database server 10 when the remotely delivered identification tag contains a web address or e-mail address for the finder of an article to contact the owner.

Referring again to FIG. 1, an alternative method for generating an identification tag uses point-of-sale system 15 to server many property owners, who may not have access to a personal computer 12 having access to network connection 11 or to create identification tags that cannot be made with typical personal computer output devices, such as laminated tags or engraved tags.

Point-of-sale system 15 may be located in a pet store, airport, or other location where identification tags may be required. Point-of-sale system 15 may be operated by an operator other than the property owner, or may be a stand-alone self assist kiosk. Point-of-sale system 15 is coupled to database server 10 through network connection 11, which may be an Internet connection as described above. A processing unit 18 includes program media containing program instructions for operating point-of-sale system 15 which may be embedded in firmware or software within processing unit 18, or may located within a web page file as described above. Processing unit 18 is coupled to network connection 11 via network interface 19 and is further coupled to an optional engraver 16 or a printer-laminator 17.

Depending on the type of output desired, computer controlled engraving machines, printers for printing on plastic and simultaneously laminating over the printed surface and embossing tools may be used. Program instructions executed by processing unit 18 request generation of identification entries within database server 10 and receive identification information from database server 10 that is then used to create an identification tag on printer-laminator 17 or engraver 16. The contact information as an Internet web address or telephone number are included as described above for identification tags generated by personal computer 12.

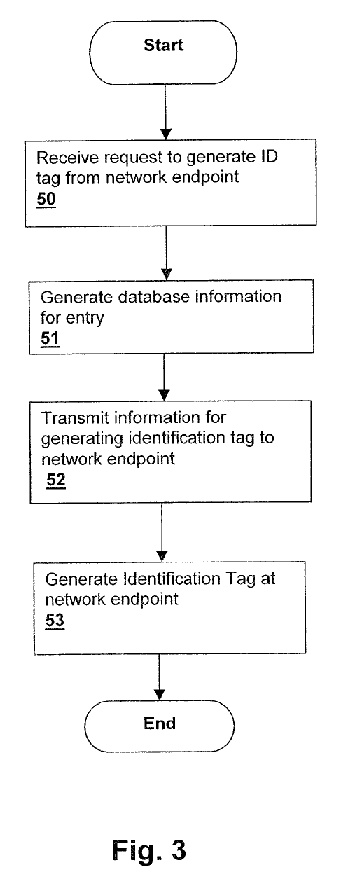

Referring now to FIG. 3, a method in accordance with a preferred embodiment of the invention is depicted in a flowchart. A request to generate an identification tag is received at database server 10 from a network endpoint (step 50). (The endpoint may be personal computer 12 or point-of-sale system 15 in the above exemplary embodiments.) Next, database server 10 generates database information for an entry associated with the request (step 51). Then, information is transmitted to the requesting endpoint for generating an identification tag (step 52). Finally, the identification tag is generated at the network endpoint (step 53) by a graphical hard-copy output device such as printer 14, printer-laminator 17 or engraver 16.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A method for delivering identification tags, comprising:
transmitting a request to generate an identification entry from a network endpoint to a centralized identification database system;
generating said identification entry at said centralized identification database system; and
second transmitting information corresponding to said identification entry from said centralized identification database system to said network endpoint for further generating an identification tag at said network endpoint, wherein said identification tag contains information for a finder of an article to contact an owner of said article.

2. The method of claim 1, wherein said second transmitting further transmits telephone number information from said centralized identification database system to said network endpoint for generating an identification tag containing contact telephone number information.

3. The method of claim 2, wherein said telephone number information represents a toll-free telephone number for generating a text representation of said toll-free telephone number on said identification tag.

4. The method of claim 2, wherein said telephone number information represents a calling card telephone number for generating a text representation of said calling card telephone number on said identification tag, whereby the purchaser of said identification tag provides a paid call to said finder.

5. The method of claim 2, wherein said telephone number is a number to a voice-messaging system whereby said finder may leave a message for said owner.

6. The method of claim 1, wherein said second transmitting further transmits e-mail address information from said centralized identification database system to said network endpoint for generating an identification tag containing an email address on said identification tag, whereby the purchaser of said identification tag provides contact information to a subsequent finder of an article to which said identification tag is affixed.

7. The method of claim 1, wherein said second transmitting further transmits web-page address information from said centralized identification database system to said network endpoint for generating an identification tag containing a web-page address on said identification tag, whereby the purchaser of said identification tag provides contact information to a subsequent finder of an article to which said identification tag is affixed.

8. The method of claim 1, wherein said network endpoint is a point-of-sale system for generating identification tags at a sales location, and wherein said method further comprises transferring graphical information for generating said identification tag to an output device at said sales location.

9. The method of claim 8, wherein said output device is an engraving device and wherein said method further comprises engraving an identification tag in response to said transferring graphical information.

10. The method of claim 8 wherein said output device is a tag printer/laminator and wherein said method further comprises printing an identification tag in response to said transferring graphical information and laminating said tag to produce a laminated identification tag.

11. The method of claim 1, wherein said network endpoint is a personal computer, and wherein said method further comprises transferring graphical information for generating said identification tag to an output device at said sales location.

12. A system comprising:
a network for connecting devices;
a centralized database coupled to said network for generating and maintaining identification information;
a network endpoint coupled to said network for generating an identification tag in response to information received from said centralized database, wherein said identification tag contains information for a finder of an article to contact an owner of said article.

13. The system of claim 12, further comprising a graphical output device for generating said identification tag.

14. The system of claim 13, wherein said graphical output device is an engraver for engraving said identification tag.

15. The system of claim 13, wherein said graphical output device is a printer/laminator for printing and laminating said identification tag.

16. The system of claim 13, wherein said network endpoint is a personal computer, said network is the Internet, and wherein said graphical output device is a personal computer printer.

17. The system of claim 16, further comprising a network browser executing from a memory contained within said personal computer, wherein said browser accesses a web page via said network, and wherein said web page contains instructions for interaction with said centralized database whereby said identification information may be generated by said centralized database and transmitted to said personal computer via said network.

18. The system of claim 13, wherein said network endpoint is a point-of-sale system for generating said identification tag at a sales location.

19. The system of claim 18, wherein said graphical output device is an engraver for engraving said identification tag at said sales location.

20. The system of claim 18, wherein said graphical output device is a printer/laminator for printing and laminating said identification tag at said sales location.

21. The system of claim 13, further comprising a voice-messaging system and wherein said information for said finder of said article to contact said owner of said article includes a telephone number to said voice-messaging system whereby said finder can contact said owner.

22. A computer program product comprising signal bearing media containing program instructions for:
accepting a user request to generate an identification tag;
requesting generation of identification information from a database;
receiving said identification information from said database; and
assembling graphical output for generating said identification tag from said identification information, wherein said identification tag contains information for a finder of an article to contact an owner of said article.

23. The computer program product of claim 22, wherein said signal bearing media is contained within a storage device coupled to the Internet and wherein said program instructions comprise instructions for generating a web page for accepting said user request and generating said identification tag.

24. The computer program product of claim 22, wherein said signal bearing media is a software program residing in memory contained within a point-of-sale identification tag generating system.
